(19) United States
(12) Patent Application Publication
(10) Pub. No.: US 2006/0245580 A1
(43) Pub. Date: Nov. 2, 2006

(54) Method and apparatus for associating customer needs with agents

(75) Inventors: Julia Hein, Huntley, IL (US); David Sells, San Francisco, CA (US); Debbie Martincich, Joliet, IL (US); Linda Steco, Fox River Grove, IL (US); Karen Mrachek, Oconomowoc, WI (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/115,640

(22) Filed: Apr. 27, 2005

(51) Int. Cl. H04M 3/00

(52) U.S. Cl. 379/265.12

(57) ABSTRACT

A customer-agent routing system (102) has a routing element (102C) for accepting customer calls and for routing said calls to an agent (108), a memory (102B) for storage of processor instructions and for storage of customer and agent activity, and a processor (102A) for controlling operations of the routing element and memory. The processor is programmed to monitor (202) operational metrics for each of a plurality of agents while serving customers, record (206) in the memory the operational metrics of each agent, and cause the routing element to route (220) a customer to an agent according to the recorded operational metrics of said agent.

### FIELD OF THE INVENTION

This invention relates generally to service center routing technologies, and more particularly to a method and apparatus for associating customer needs with agents.

### BACKGROUND OF THE INVENTION

Service centers often have banks of representatives (agents) who serve a number of customer needs such as, for example, billing inquiries, request for new service(s), and/or request for change of service(s), just to mention a few. A service provider can grow its revenue base by assuring that these agents effectively match products with customer needs while providing exceptional customer care. Another aspect of interest to the service provider is in optimizing the time to process customer-agent transactions without foregoing customer care.

Today service providers train their agents to serve a variety of customer needs while attempting to optimize the foregoing business considerations among others. Although agent evaluations provide the service provider an indication of how well the agent is performing, often such reviews fall short of capitalizing on an agent's strengths while mitigating his or her weaknesses.

### SUMMARY OF THE INVENTION

Embodiments in accordance with the invention provide a method and apparatus for associating customer needs with agents.

In a first embodiment of the present invention, a computer-readable storage medium is utilized for routing customers. The storage medium comprises computer instructions for monitoring operational metrics for each of a plurality of agents while serving customers, recording the operational metrics of each agent, and routing a customer to an agent according to the recorded operational metrics of said agent.

In a second embodiment of the present invention, a customer-agent routing system has a routing element for accepting customer calls and for routing said calls to an agent, a memory for storage of processor instructions and for storage of customer and agent activity, and a processor for controlling operations of the routing element and memory. The processor is programmed to monitor operational metrics for each of a plurality of agents while serving customers, record in the memory the operational metrics of each agent, and cause the routing element to route a customer to an agent according to the recorded operational metrics of said agent.

In a third embodiment of the present invention, a method is provided for routing customers to agents. The method has the steps of monitoring operational metrics for each of a plurality of agents while serving customers, recording the operational metrics of each agent, and routing a customer to an agent according to the recorded operational metrics of said agent.

### BRIEF DESCRIPTION OF THE DRAWINGS

FIG. 1 is block diagram of a customer-agent routing system operating in a communication system according to an embodiment of the present invention; and

FIG. 2 depicts a flow chart of a method operating in the customer-agent routing system according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

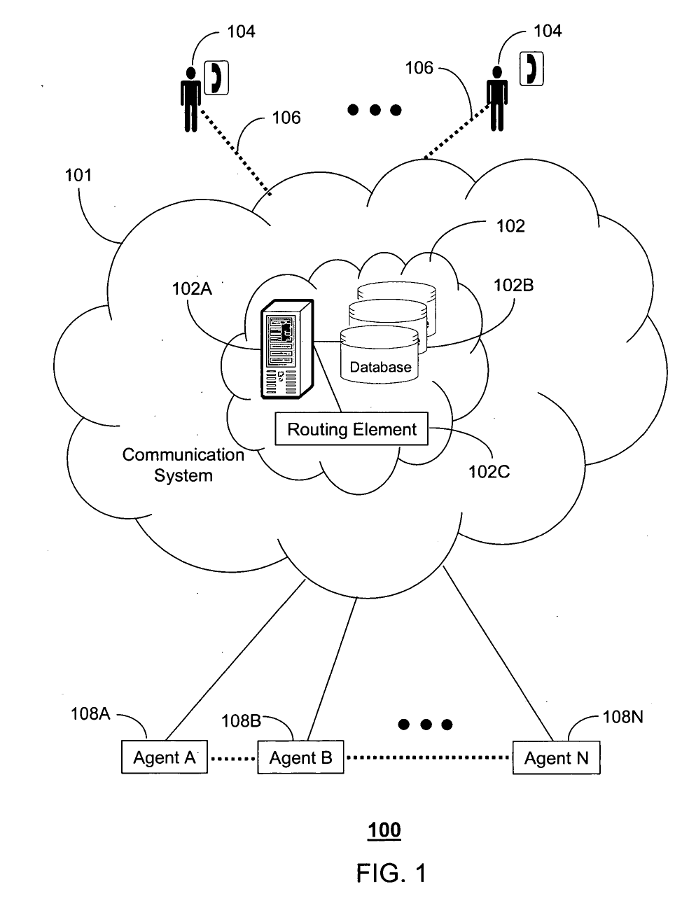

FIG. 1 is block diagram of a customer-agent routing system 102 operating in a communication system 101 according to an embodiment of the present invention. The customer-agent routing system 102 comprises conventional technology such as a routing element 102C, a memory 102B, and processor 102A. The processor 102A can utilize one or more conventional computers or servers for controlling operations of the customer-agent routing system 102. The memory 102B utilizes one or more conventional media devices (such as a high capacity disk drive, Flash memory, Dynamic Random Access Memory, or other like memories) for storage purposes, and can be used for managing databases of a service provider of said system 102.

The routing element 102C can comprise conventional routing technology similar to that of an ACD (Automatic Call Distributor) for routing customers 104 to selected agents 108A-N coupled to the communication system 101. In the present context an agent 108 can be a human agent, or a computing system such as an IVR (Interactive Voice Response) system emulating a human agent by way of voice recognition technology and text-to-speech technology for exchanging messages with the customer 104. Similarly, the customer-agent routing system 102 can utilize the functionality of a conventional IVR system for communicating with the customer 104. Although the processor 102A, memory 102B and routing element 102C are shown separately, they can be in the alternative an integral unit.

It should also be noted that the communication system 101 can utilize wire line and/or wireless technologies for providing the customer 104 access to the customer-agent routing system 102 in a geographic region covered by said system 101. The customer 104 is coupled to the communication system 101 by way of a wire line or wireless interface 106 for exchanging communications thereon.

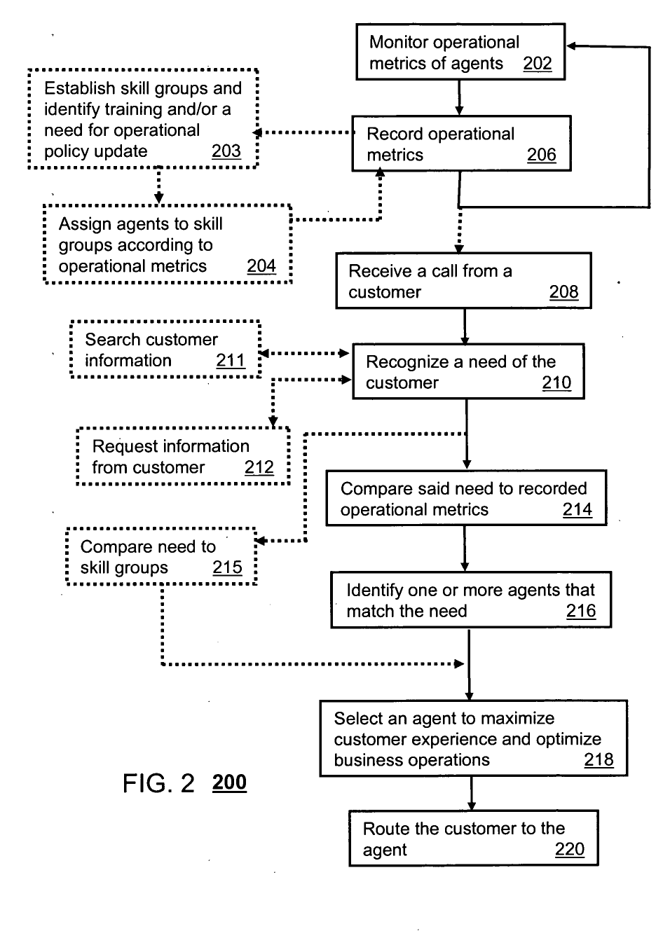

FIG. 2 depicts a flow chart of method 200 operating in the customer-agent routing system 102 according to an embodiment of the present invention. Method 200 begins with step 202 where each agent is monitored according to operational metrics established by the service provider of said system 102. The operational metrics monitored for each agent can be a combination of two or more metrics including, but not limited to, customers served, opportunities available for offering new products or services to a customer, opportunities executed, offers matched with a customer, offers mismatched with a customer, change requests by a customer of a previously offered product or service, handovers to other agents, or miscellaneous number of customers served.

It will be appreciated by one of ordinary skill in the art that the above examples are a limited set and can be expanded to any number of metrics relevant to assessing an agent's skills and associated performance. Additionally, it should be evident to said artisan that operational metrics can evolve over time as business and customer needs change. Accordingly, any operational metrics that can serve to manage and improve the skills and performance of agents are applicable to the claimed invention as described herein.

The aforementioned monitored operational metrics are recorded in step 206. These records can be maintained in conventional databases 102B managed by, for example, a conventional CRM (Customer Relations Management) system. From these databases, the service provider can track and report changes in the operational metrics at an individual, a group or a division level of service center agents. Moreover, reporting can be performed from the lowest to the highest levels of an organization for any timeframe (real-time to daily, monthly, date range, or the like). Such reports can be used for continuous improvement of individuals, groups, or divisions of an enterprise.

As a supplemental embodiment, the recorded operational metrics and changes monitored therein can be used for evaluating agents in step 203. Generally speaking, human or computer emulated agents (e.g., an IVR system) can be organized according to skill groups. For example, from the measured metrics it may be determined that a select group of agents perform below average with respect to sales of new and existing services of the service provider, but perform at or above average in answering billing or service inquiries of customers 104 in a timely manner. These agents can be assigned in step 204 in a skill group that serves customer inquiries. Other agents, on the other hand, who have demonstrated from their operational metrics an ability for timely sales with good customer care are assigned in step 204 in a skill group for sales of products and services. Agents who perform well in multiple skill areas can be placed in more than one skill group.

In a hybrid agent environment such as this, step 203 can serve to identify training needs for human agents according to the recorded operational metrics of said agents, and a need for updating the operational policy followed by a human agent and/or IVR system-agent. This step can also identify instances where an IVR system can be more effective than a human agent, and vice-versa.

As shown by the feedback path of step 206, the processor 102B can be programmed to execute steps 202-206 in whole or in part iteratively as often as the service provider desires. Additionally, these steps can be performed by the processor 102A as a background process in a multi-tasking environment (as represented by the dashed line into step 208), thereby providing a method for frequently monitoring the skill and associated performance of each agent 108 while they serve customers 104.

From the above skill and performance analysis of agents, calls from customers 104 in step 208 can be assessed by the customer-agent routing system 102 for optimal routing. To assist in associating the customer 104 with an agent 108, the customer-agent routing system 102 determines a need of the customer in step 210. This need can be recognized from a number of sources including, but not limited to, searching information about the customer stored in one of the databases 102B or from information proactively provided by the customer. In the former case, the information can be pre-recorded information about an existing customer of the service provider. Such pre-recorded information can include information relating to services the customer has subscribed to, billing history of the customer, number of changes requested by the customer, or any number of other known characteristics of the customer.

Alternatively, the customer may be unsubscribed in which case, marketing, demographic and/or psychographic information can be included in the databases 102B, which can assist the agent in step 211 to assess the needs of the customer 104. In this case, the caller ID of the customer, zip code, or other form of identification can be used to indirectly, or proactively with the assistance of the customer 104, determine an expected need of the customer.

It should be noted that the proactive exchange with the customer 104 can be readily executed by an IVR system-agent. Additionally, the repository of databases 102B storing the marketing and current customer information can be managed by a conventional CRM system as described above.

By the determining the expected needs of the customer as described above, agents can identify sales opportunities based on the portfolio of product and services available to the service provider, and couple such opportunities with serving the immediate needs of the customer. These opportunities and the executed or non-execution of such opportunities can be monitored in background steps 202-206 as described earlier.

Once the need(s) of the customer 104 are understood in whole or in part, said needs are then compared in step 214 to the recorded operational metrics of each agent 108. In step 216 one or more agents are identified that match the need of the customer. In an alternative embodiment, said needs can be compared to the skill groups created in step 205. From either of these embodiments, an agent can be selected in step 218 to maximize an experience of the customer 104 and optimize business operations of the service provider. This can be accomplished by the service provider by establishing experience and business objectives.

Experience objectives can include, for instance, satisfying the needs of the customer according to an expected skill level of the agent, and/or satisfying the needs of the customer in a timely manner according to an expected performance of the selected agent. The business objectives can include, for example, maximizing sales to the customer of products or services of the service provider, serving the customer as quickly as possible without foregoing potential sales opportunities and customer satisfaction, and/or improving customer loyalty by maximizing customer satisfaction. These combined objectives can serve to improve sales revenue, operational efficiency, and customer care of the service provider.

Once an agent 108 has been selected in step 218, the customer 104 is routed to said agent in step 220 by the customer-agent routing system 102. The routing of the agent can be performed by the ACD described above or other existing or future routing technology suitable for the claimed invention described herein. Over the course of time, the background execution of steps 202-206 form the basis for continuously improving the process of associating customers 104 with agents 108. Accordingly, the routing step 220 can be periodically adjusted as the skill and performance of agents 108 change.

It should be evident by now that the present invention can be realized in hardware, software, or a combination of hardware and software. Moreover, the present invention can be realized in a centralized fashion, or in a distributed fashion where different elements are spread across several interconnected processors. Any kind of computer device or other apparatus adapted for carrying out method 200 described above is suitable for the present invention.

Additionally, the present invention can be embedded in a computer program product, which comprises all the features enabling the implementation of method 200, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form. It should be also evident that the present invention may be used for many applications. Thus, although the description is made for particular arrangements and methods, the intent and concept of the invention is suitable and applicable to other arrangements and applications not described herein. For example, method 200 can be reduced to steps 202, 206 and 220 without departing from the scope and spirit of the claimed invention. This is but one of many embodiments that can be derived by modifying method 200. It would be clear therefore to those skilled in the art that modifications to the disclosed embodiments described herein could be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A computer-readable storage medium for routing customers, the storage medium comprising computer instructions for:
monitoring operational metrics for each of a plurality of agents while serving customers;
recording the operational metrics of each agent; and
routing a customer to an agent according to the recorded operational metrics of said agent.

2. The storage medium of claim 1, further comprising computer instructions for detecting a change in one or more skills and associated performance of said skills for each agent.

3. The storage medium of claim 2, further comprising computer instructions for:
establishing a plurality of skill groups;
assigning each agent to one or more of the plurality of skill groups according to recorded operational metrics of each agent;
recognizing a need of the customer;
comparing said need to the skill groups;
selecting an agent from the selected skill group; and
routing the customer to said agent.

4. The storage medium of claim 3, further comprising computer instructions for identifying for each agent at least one among a group comprising a need for training according to the recorded operational metrics of the agent, and a need for updating the operational policy followed by the agent.

5. The storage medium of claim 1, further comprising computer instructions for adjusting customer routing according to changes in the recorded operational metrics of each agent.

6. The storage medium of claim 1, further comprising computer instructions for:
recognizing a need of the customer;
comparing said need to the recorded operational metrics of each agent;
identifying one or more agents that match the need of the customer with the recorded operational metrics of the one or more agents;
selecting an agent from the one or more agents; and
routing the customer to said agent.

7. The storage medium of claim 6, further comprising computer instructions for:
maximizing an experience of the customer according a experience objective; and
optimizing business operations of a service provider according to a business objective.

8. The storage medium of claim 7, wherein the experience objective is among at least one of a group of experience objectives comprising satisfying the needs of the customer according to an expected skill level of the agent, and satisfying the needs of the customer in a timely manner according to an expected performance of the select agent, and wherein the business objective is among at least one of a group of business objectives comprising maximizing sales to the customer of products or services of the service provider, serving the customer as quickly as possible without foregoing potential sales opportunities and customer satisfaction, and improving customer loyalty by maximizing customer satisfaction.

9. The storage medium of claim 1, further comprising computer instructions for reporting upon request recorded operational metrics for each agent, and wherein the operational metrics for each agent are selected from two or more of a group of metrics comprising customers served, opportunities available for offering new products or services to a customer, opportunities executed, offers matched with a customer, offers mismatched with a customer, change requests by a customer of a previously offered product or service, handovers to other agents, and miscellaneous customers served.

10. The storage medium of claim 1, wherein each of the plurality of agents is among one of a group comprising a computing system emulating a human agent, and a human agent.

11. A customer-agent routing system, comprising:
a routing element for accepting customer calls and for routing said calls to an agent;
a memory for storage of processor instructions and for storage of customer and agent activity; and
a processor for controlling operations of the routing element and memory, wherein the processor is programmed to:
monitor operational metrics for each of a plurality of agents while serving customers;
record in the memory the operational metrics of each agent; and
cause the routing element to route a customer to an agent according to the recorded operational metrics of said agent.

12. The customer-agent routing system of claim 11, wherein agent activity is stored as a database in the memory, and wherein said database is updated by a customer relations management system that tracks agent activity.

13. The customer-agent routing system of claim 11, wherein the processor is further programmed to detect in the memory a change in one or more skills and associated performance of said skills for each agent.

14. The customer-agent routing system of claim 13, wherein the processor is further programmed to:
establish a plurality of skill groups;
assign each agent to one or more of the plurality of skill groups according to recorded operational metrics of each agent;
recognize a need of the customer;
compare said need to the skill groups;
select an agent from the selected skill group; and
cause the routing element to route the customer to said agent.

15. The customer-agent routing system of claim 14, wherein the processor is further programmed to identify for each agent at least one among a group comprising a need for training according to the recorded operational metrics of the agent, and a need for updating the operational policy followed by the agent.

16. The customer-agent routing system of claim 11, wherein the processor is further programmed to adjust customer routing according to changes in the recorded operational metrics of each agent.

17. The customer-agent routing system of claim 14, wherein the processor is programmed to recognize the need according to one among a group of sources comprising information about the customer stored in the memory and information provided proactively by the customer.

18. The customer-agent routing system of claim 11, wherein the processor is further programmed to:
recognize a need of the customer;
compare said need to the recorded operational metrics of each agent in the memory;
identify in the memory one or more agents that match the need of the customer with the recorded operational metrics of the one or more agents;
select an agent from the one or more agents; and
cause the routing element to route the customer to said agent.

19. The customer-agent routing system of claim 18, wherein the processor is further programmed to:
maximize an experience of the customer according a experience objective; and
optimize business operations of a service provider according to a business objective.

20. The customer-agent routing system of claim 19, wherein the experience objective is among at least one of a group of experience objectives comprising satisfying the needs of the customer according to an expected skill level of the agent, and satisfying the needs of the customer in a timely manner according to an expected performance of the select agent, and wherein the business objective is among at least one of a group of business objectives comprising maximizing sales to the customer of products or services of the service provider, serving the customer as quickly as possible without foregoing potential sales opportunities and customer satisfaction, and improving customer loyalty by maximizing customer satisfaction.

21. The customer-agent routing system of claim 11, wherein the processor is further programmed to report upon request recorded operational metrics for each agent, and wherein the operational metrics for each agent are selected from two or more of a group of metrics comprising customers served, opportunities available for offering new products or services to a customer, opportunities executed, offers matched with a customer, offers mismatched with a customer, change requests by a customer of a previously offered product or service, handovers to other agents, and miscellaneous customers served.

22. The customer-agent routing system of claim 11, wherein each of the plurality of agents is among one of a group comprising a computing system emulating a human agent, and a human agent.

23. The customer-agent routing system of claim 11, wherein the routing element comprises at least one among a group comprising an interactive voice response (IVR) system for interacting with the customer as instructed by the processor, and an automatic call distributor (ACD) for receiving a call from the customer and routing said customer to a select agent as instructed by the processor.

24. A method for routing customers to agents, comprising the steps of:
monitoring operational metrics for each of a plurality of agents while serving customers;
recording the operational metrics of each agent; and
routing a customer to an agent according to the recorded operational metrics of said agent.

25. The method of claim 24, further comprising the step of detecting a change in one or more skills and associated performance of said skills for each agent.

26. The method of claim 25, further comprising the steps of:
establishing a plurality of skill groups;
assigning each agent to one or more of the plurality of skill groups according to recorded operational metrics of each agent;
recognizing a need of the customer;
comparing said need to the skill groups;
selecting an agent from the selected skill group; and
routing the customer to said agent.

27. The method of claim 26, further comprising the step of identifying for each agent at least one among a group comprising a need for training according to the recorded operational metrics of the agent, and a need for updating the operational policy followed by the agent.

28. The method of claim 24, further comprising the step of adjusting customer routing according to changes in the recorded operational metrics of each agent.

29. The method of claim 24, further comprising the steps of:
recognizing a need of the customer;
comparing said need to the recorded operational metrics of each agent;
identifying one or more agents that match the need of the customer with the recorded operational metrics of the one or more agents;
selecting an agent from the one or more agents; and
routing the customer to said agent.

30. The method of claim 29, further comprising the steps of:
maximizing an experience of the customer according a experience objective; and
optimizing business operations of a service provider according to a business objective.
